(19) United States
(12) Patent Application Publication
(10) Pub. No.: US 2010/0316841 A1
(43) Pub. Date: Dec. 16, 2010

(54) LAMINATION PROCESS FOR PRODUCING SECURITY LAMINATES

(75) Inventor: Ingrid Geuens, Emblem (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: AGFA-GEVAERT, Mortsel (BE)

(21) Appl. No.: 12/866,812

(22) PCT Filed: Mar. 26, 2009
(86) PCT No.: PCT/EP09/53592

§ 371 Date: Aug. 9, 2010

Related U.S. Application Data
(60) Provisional application No. 61/041,488, filed on Apr. 1, 2008.

(30) Foreign Application Priority Data
Apr. 1, 2008 (EP) 08103286.4

(51) Int. Cl. B32B 3/10; B32B 27/36; B32B 37/14; B32B 38/04

(52) U.S. Cl. 428/137; 428/522; 156/293; 156/256

(57) ABSTRACT

A process for producing a security laminate comprising a plurality of lamellae and layers, comprising the steps of: a) providing at least one film, at least a first and a second prelaminate and a contactless module, wherein the contactless module is not incorporated in the prelaminate or the film; and b) laminating in one step together the at least first prelaminate, the at least one film, the contactless module and the at least second prelaminate to provide the security laminate.

### FIELD OF INVENTION

This invention relates to a lamination process for producing security laminates.

### BACKGROUND OF THE INVENTION

The term “security laminate” encompasses tamper proof seals on medications, video cassettes, compact discs, and packaging; security features on labels and tags; and identification documents, which includes documents; magnetic disks; cards involved in the electronic transfer of money such as bank cards, cheque cards, pay cards, credit cards and debit cards; phone cards; stored value cards; prepaid cards; shopping cards; loyalty cards; smart cards (e.g., cards that include one more semiconductor chips, such as memory devices, microprocessors, and microcontrollers); contact cards; contactless cards; proximity cards (e.g., radio frequency (RFID) cards); passports; driving licenses; network access cards; employee badges; security cards; visas; immigration documentation; national ID cards; citizenship cards; social security cards and badges; medical care cards; certificates; identification cards or documents; voter registration and/or identification cards; police ID cards, border crossing cards; security clearance badges and cards authorizing access to the bearer of the card to particular areas such as a company (employee ID card), the military and a public service; gun permits; badges; gift certificates or cards; membership cards or badges of clubs and societies; tags; CD's; consumer products; knobs; keyboards; electronic components, etc., or any other suitable items or articles that may record information, images, and/or other data, which may be associated with a function and/or an object or other entity to be identified.

Five features are particularly important when producing and using security laminates. First, once applied to an article it is important that the laminate is difficult to remove to ensure that the underlying item is not altered or subjected to tampering. Second, a desirable laminate is difficult if not impossible to duplicate by counterfeiters. Third, if tampering occurs it is important to quickly and accurately recognize an altered or counterfeit laminate. Fourth, it is important that manufacturing costs of the laminates are not prohibitively expensive. Fifth, when used on articles such as identification cards, it is important that the laminate has sufficient durability to withstand harsh treatment.

There are usually two types of “printing” on security laminates. The first type of printing involves a “background” printing made up of reference and security information. The reference information may include, for example, the issuing agency, as well as other numerical data. The security information may be in the form of a watermark, an encoded magnetic strip, numerical sequences, a holographic image, etc. The second type of printing is made up of “personalized” information, such as a photographic, fingerprint, signature, name, address, etc.

U.S. Pat. No. 4,552,383 discloses an identification card or similar data carrier incorporating an IC module, the IC module being arranged on a carrier element, the identification card having a plurality of card layers and including a recess in an area in which the carrier element is positioned, at least two of the card layers positioned adjacent to the recess, a supporting layer being attached to each of the at least two card layers, each supporting layer comprising means for stabilizing the shape of the card layers during hot lamination of the card.

GB 2279610A discloses a method of manufacturing a laminated card one layer of which comprises a printed circuit having components thereon, the method comprising placing the printed circuit and a sheet of protective thermoplastic material together in a press, evacuating and heating the sheet and the printed circuit, and pressing the printed circuit and sheet together such that components on the printed circuit become embedded in the sheet of protective material.

U.S. Pat. No. 5,804,026 discloses a method for producing an identity card sandwich, the method comprising the steps of: positioning a plurality of card layers one on top of another, the plurality of card layers including at least an intermediate layer adjacent to a first of the plurality of card layers and at least one electronic component initially positioned on the intermediate layer; applying adhesive to at least one out of a first surface of the intermediate layer and an inner surface of the first card layer adjacent to the first surface; applying pressure without applying heat to the plurality of card layers to compress the card layers to a predetermined width; and curing the adhesive layer to secure the electronic component.

JP 2000-085282A discloses a noncontact IC card comprising an IC chip for connecting an antenna coil between terminals and embedded in a card base, one or two amorphous copolyester sheet layers laminated on both surfaces of the coil via mesh sheets and integrated as card base by heat fusion bonding.

JP 2005-293396A discloses a layered body, in which inlets, upper and lower core sheets, and upper and lower over-sheets are layered, is pressed and heated by a press for fusing and integrally bonding opposite faces of the upper and lower core sheets and the opposite faces of the core sheet and the over-sheet, the layered core sheet and the over-sheet being fused to be dispersed evenly substantially to a part, in which an IC chip is covered, in the inlet; and then the layered body is cooled to a temperature at which a PET-G resin is hardened to be hardened while at least the outside face of the over-sheet layered in the part, in which the IC chip is covered, is pressed and held to thickness giving a substantially flat outside face for the over-sheet.

U.S. Pat. No. 6,514,367 discloses a process for incorporating at least one electronic element in the manufacture of a plastic card, comprising the steps of: (a) providing first and second plastic core sheets: (b) positioning the at least one electronic element in the absence of a non-electronic carrier directly between the first and second plastic core sheets to form a core, the plastic core sheets defining a pair of inner and outer surfaces of the core; (c) positioning the core in a laminator apparatus, and subjecting the core to a heat and pressure cycle, the heat and pressure cycle comprising the steps of: (i) heating the core for a first period of time; (ii) applying a first pressure to the core for a second period of time such that the at least one electronic element is encapsulated by the core; (iii) cooling the core while applying a second pressure to the core, the second pressure being at least 10% greater than the first pressure; and (d) milling a region of the core to a controlled depth so as to form a cavity which exposes at least one contact pad of the at least one electronic element.

U.S. Pat. No. 6,803,114 discloses a card comprising a card body including at least three laminated plastic layers directly superimposed on each other, a second layer being a layer of polyethylene terephthalate glycol placed between a first layer and a third layer, the first layer and third layer being of a chemical nature different from that of the second layer, an electronic module being incorporated in a cavity of the card body, the module comprising an integrated circuit, wherein the thickness of the second layer is of the same order of magnitude as that of the first and third layers, and wherein the cavity extends into the second layer from the first layer, and wherein the electronic module is secured within the cavity by liquefied polyethylene terephthalate glycol from the second layer. U.S. Pat. No. 6,803,114 further discloses a manufacturing process for a card comprising a card body including at least three laminated plastic layers directly superimposed on each other, a second layer being a layer of polyethylene terephthalate glycol placed between a first layer and a third layer, the first layer and third layer being of a nature different from that of the second layer, an electronic module being incorporated in the card body, the module comprising an integrated circuit, comprises the steps of: laminating the first layer, second layer, and third layer together so as to obtain a first laminated assembly, the second layer having a thickness of the same order of magnitude as that of the first and third layers; creating a cavity extending into the second layer from the first layer; inserting the module in the cavity; and liquefying at least a portion of the second layer such that liquefied polyethylene terephthalate glycol flows into the cavity to secure the module.

WO 99/24934A discloses a method for the production of personalized, contactless or regular, smart cards or smart card pouches, which comprises the steps of: 1) providing a foundation layer; 2) applying to it the electronic components that are desired in the smart card; 3) applying a filling to the foundation layer carrying the electronic components, whereby to create a base layer having a thickness corresponding to the dimensions of the electronic components; 4) providing two intermediate layers of plastic matter; 5) providing two cover sheets of plastic matter, one of which at least is transparent; 6) applying to at least a substrate, chosen from among the intermediate layers and the cover sheets, the desired personalizing graphic matter; 7) juxtaposing the intermediate layers to the base layer and connecting them to it by lamination over their entire surfaces, to form a core; 8) juxtaposing the cover sheets to the core; 9) laminating the cover sheets to the core to produce a composite sheet; and 10) detaching individual segments from the composite sheet.

The prior art security laminates with contactless modules suffer from topographical defects resulting in unpredictable security laminate thicknesses and imperfect masking of the module due to thinning of the opaque masking film observed as black rims as well as significant air entrapment.

### ASPECTS OF THE INVENTION

It is therefore an aspect of the present invention to provide a process for producing a security laminate with minimal topographical defects and without black rims.

It is a further aspect of the present invention to avoid significant air entrapment.

Further aspects of the present invention will become apparent from the description hereinafter.

### SUMMARY OF THE INVENTION

In the art of the production of security laminates with contactless modules it is conventional, for reasons of exact placement of the contactless module, reduced thermal stress for the contactless module and expected incompatibility of the contactless module with and poor adhesion to the lamellae of the security laminate, first to incorporate the contactless module in a prelaminate extending to the edges of the envisaged security laminate. The prelaminate with the contactless module is then further involved in one or more further steps eventually resulting in a security laminate. Surprisingly, despite any placement, thermal stress, incompatibility and adhesion problems, it has been found that the use of a single step process in respect of the incorporation of the contactless module enables the topographical defects resulting in unpredictable security laminate thicknesses and the imperfect masking of the module due to thinning of the opaque masking film, observed as a black rim, to be significantly reduced. These topographical problems appear to be due a sensitivity of the support of the contactless modules optionally carrying an antenna to thermal stress resulting in their buckling, despite the contactless devices produced at much higher temperatures than those to which they are exposed to during lamination. It is therefore surprising that such buckling is substantially reduced in a one step process, despite the temperatures to which the contactless module is exposed being higher than in the case of incorporation in a prelaminate and the incorporation of the prelaminate in one or more processes into a security laminate. Furthermore, the use of a vacuum laminator substantially eliminates the incorporation of air bubbles. Additional benefits were an increased productivity both through the simplified lamination processes and due to an elimination of rejected prelaminate units due to poor/incomplete embedding of the module.

Aspects of the present invention were realized by a process for producing a security laminate according to claim 1.

Preferred embodiments are disclosed in the dependent claims.

### BRIEF DESCRIPTION OF THE DRAWINGS

FIG. 1 shows schematically the second step of a two step process for producing a security laminate from prelam I [8], prelam VII [9] and prelam II [10] outside the scope of the present invention.

FIG. 2a) shows schematically the second step of a two step process for producing a security laminate from prelam III [11], prelam VII [9] and prelam IV [12] outside the scope of the present invention (see COMPARATIVE EXAMPLE 1).

FIG. 2b) shows schematically the lamination of both sides of the security laminate resulting from the process shown in FIG. 2a) with a protective laminate [13, 13′].

FIG. 3 shows schematically a first embodiment of the one step process, according to the present invention.

FIG. 4 shows schematically a second embodiment of the one step process, according to the present invention.

FIG. 5 shows schematically a third embodiment of the one step process, according to the present invention.

FIG. 6 shows schematically a fourth embodiment of the one step process, according to the present invention.

FIG. 7 shows schematically a fifth embodiment of the one step process, according to the present invention.

FIG. 8 shows schematically a sixth embodiment of the one step process, according to the present invention.

FIG. 9 shows schematically a seventh embodiment of the one step process, according to the present invention.

### DETAILED DESCRIPTION OF THE INVENTION

### Definitions

The term “security laminate”, as used in disclosing the present invention, means a laminate with all security features optionally laminated in a further lamination step with a protective laminate prior to cutting to the final format.

The term “lamella”, as used in disclosing the present invention, means a thin polymeric sheet optionally provided with an adhesive system used in producing laminates using pressure optionally together with heat. The term “lamellae” includes films and prelaminates.

The term “adhesion system”, as used in disclosing the present invention, means one or more layers providing an adhesive entity.

The term “film”, as used in disclosing the present invention, means a self-supporting polymer-based sheet, which may be associated with adhesion layers e.g. subbing layers.

The term “layer system”, as used in disclosing the present invention, means one or more layers contiguous with one another.

The term “contactless module”, as use in disclosing the present invention, means an electronic module capable of contactless communication. Such contactless communication requires the presence of an antenna coupled to the electronic chip, the antenna being either mounted on the same support as the chip or being on a separate support.

The term “one step process”, as used in disclosing the present invention, means that the contactless laminate, optionally with films laminated thereon, is involved in a single step process in the production of the security laminate i.e. excludes encapsulation of the contactless module in a prelaminate extending to the edges of the security laminate. This is to be distinguished from two, three or n step processes in which the contactless laminate, optionally with films laminated thereon, is involved in a two, three or n-step process in the production of the security laminate.

The term “buckling”, as used in disclosing the present invention, means extreme curvature e.g. due to thermal stress on a inadequately thermally stabilized support.

PE is an abbreviation for polyethylene.

PC is an abbreviation for polycarbonate.

PET is an abbreviation for polyethylene terephthalate.

PET-C is an abbreviation for biaxially stretched polyethylene terephthalate.

PETG is an abbreviation for polyethylene terephthalate glycol, the glycol indicating glycol modifiers i.e. partial replacement of ethylene glycol by alternative glycols such as 1,4-cyclohexane-dimethanol or neopentyl glycol which minimize brittleness and premature aging that occur if unmodified amorphous polyethylene terephthalate (APET) is used in the production of cards.

### Process for Producing a Security Laminate

Aspects of the present invention were realized by a process for producing a security laminate comprising a plurality of lamellae and layers, comprising the steps of:
a) providing at least one film, at least a first and a second prelaminate and a contactless module, wherein the contactless module is not incorporated in the prelaminate or the film; and
b) laminating in one step together the at least first prelaminate, the at least one film, the contactless module and the at least second prelaminate to provide the security laminate.

In a preferred embodiment of the process for producing a security laminate, according to the present invention, the lamination is performed in a vacuum laminator. A vacuum of 20-30 mbar is available in vacuum laminators such as a Lauffer lamination System Type LC 70. However, a vacuum of 500 mbar is sufficient to substantially eliminate air bubbles.

In a preferred embodiment of the process for producing a security laminate, according to the present invention, the security laminate comprises at least one axially stretched linear polyester film.

In a preferred embodiment of the process for producing a security laminate, according to the present invention, at least one of the outermost lamellae of the security laminate is an axially stretched linear polyester film.

In a preferred embodiment of the process for producing a security laminate, according to the present invention, at least one of the outermost lamellae of the security laminate is a biaxially stretched linear polyester film.

In a preferred embodiment of the process for producing a security laminate, according to the present invention, the security laminate comprises at least one lamella selected from the group consisting of crystalline polyester lamellae, amorphous polyester lamellae, polycarbonate lamellae, polyolefin lamellae and polyvinyl chloride lamellae.

In a preferred embodiment of the process for producing a security laminate, according to the present invention, the contactless module is placed in a punched out lamella prior to the lamination step.

In a preferred embodiment of the process for producing a security laminate, according to the present invention, the security laminate is an identity document.

In a preferred embodiment of the process for producing a security laminate, according to the present invention, the security laminate is an identification card.

In a preferred embodiment of the process for producing a security laminate, according to the present invention, the security laminate is a contactless smart card.

In a preferred embodiment of the process for producing a security laminate, according to the present invention, the security laminate is not a contact smart card.

Pre-cut ID card stock can be easily produced by conventional methods using the above-described composite film structure in the conventional shape, size, e.g., 54.5 mm×86 mm, and having a thickness of about 0.8 mm. A pre-cut card stock is one which is made to the card size specifications before printing and exits the printer system without any further trimming or cutting required. An overcoat laminate may be applied after printing if desired.

The thickness of both the polymeric core substrate and oriented polymeric film is variable, but the overall thickness is usually in the range of 685 to 838 pm. The outer surfaces of the ID card stock can be printed with dye images or text. Optionally, non-varying information, such as lines, line segments, dots, letters, characters, logos, guilloches, etc., can be printed on the polymeric core substrate by non-thermal dye transfer methods such as flexo or offset printing before attaching the polymeric core substrate to the oriented polymeric film or films carrying the external dye-receiving layer or layers.

The composite ID card stock of the invention can also be readily milled for placement of a memory chip. Alternatively, the polymeric core substrate and an oriented polymeric film can be pre-punched before attaching to provide a suitable site for a memory chip or in the case of contactless applications the chip can be interlaminated.

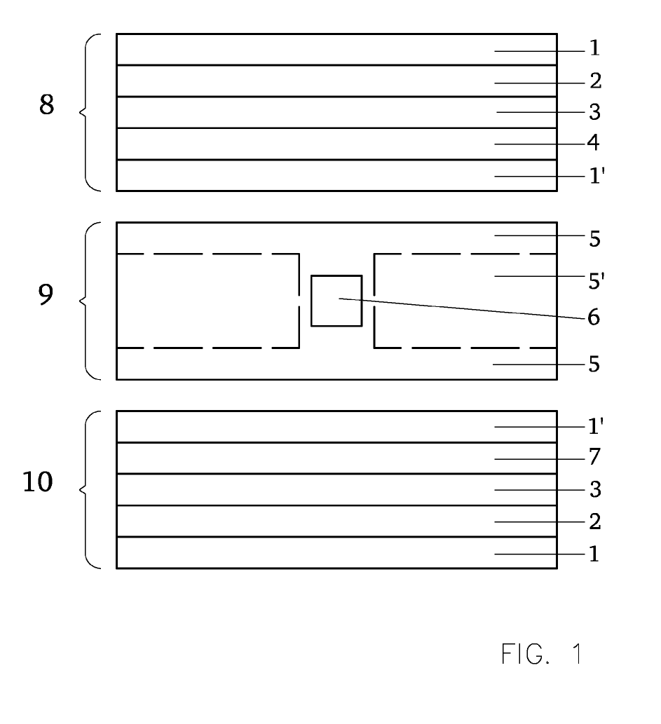

FIG. 1 shows schematically the second step of a two step process for producing a security laminate by laminating prelaminate I [8] consisting of PET-C films [1, 1′] with different layer thicknesses, a PE film [2], security printing [3] and a layer system with a protective layer, a gelatinous DTR-receiving layer and a further gelatinous layer [4]; prelaminate VII [9] consisting of two PETG films [5] sandwiching a punched PETG film [5′] with a module [6] in the punched out part; and prelaminate II [10] consisting of PET-C films [1, 1′] with different layer thicknesses, a PE film [2], security printing [3] and a layer system with a protective layer [7].

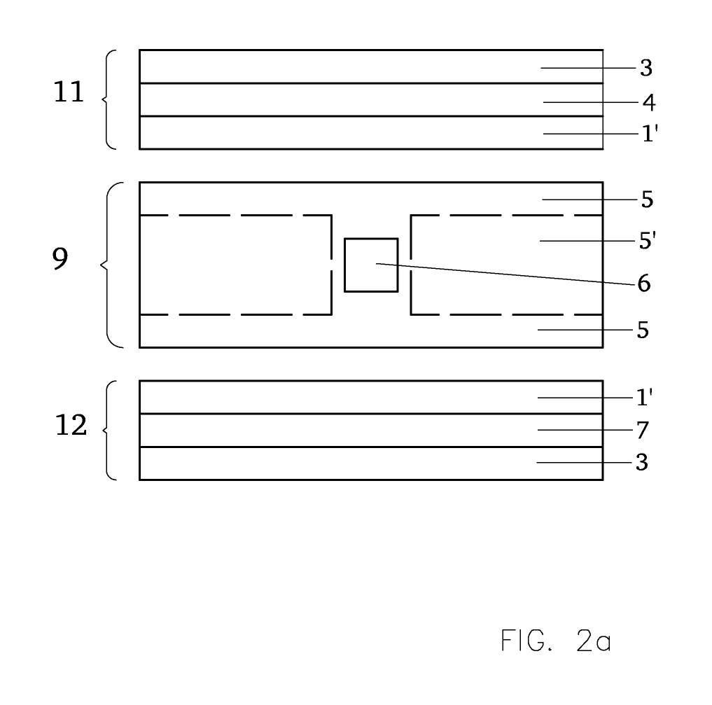

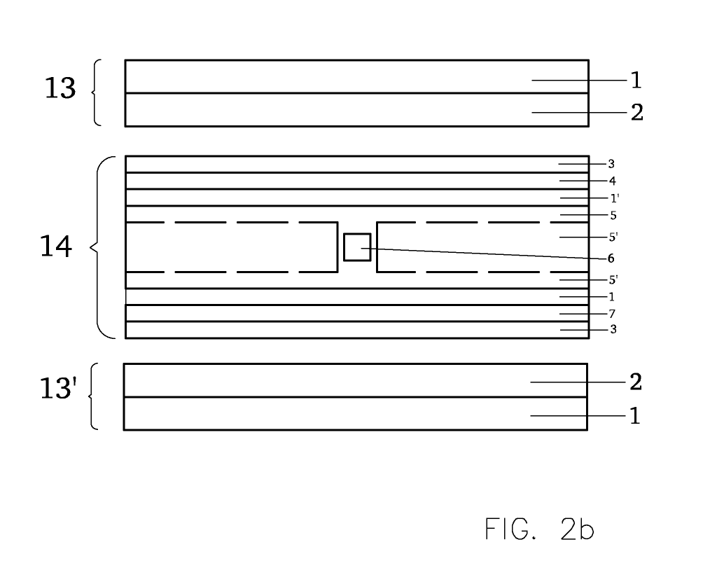

FIG. 2a) shows schematically the second step of a two step process for producing a security laminate by laminating prelaminate III [11] consisting of a PET-C film [1′], security printing [3] and a layer system with a protective layer, a gelatinous DTR-receiving layer and a further gelatinous layer [4]; prelaminate VII [9] consisting of two PETG films [5] sandwiching a punched PETG film [5′] with a module [6] in the punched out part; and prelaminate IV [12] consisting of a PET-C film [1′], security printing [3] and a layer system with a protective layer [7] ((see COMPARATIVE EXAMPLE 1).

FIG. 2b) shows schematically the lamination of the two sides of the security laminate produced by the process shown in FIG. 2a with a protective laminate [13] e.g. a PET-C/PE laminate and a further protective laminate [13′] e.g. a PET-C/PE laminate respectively.

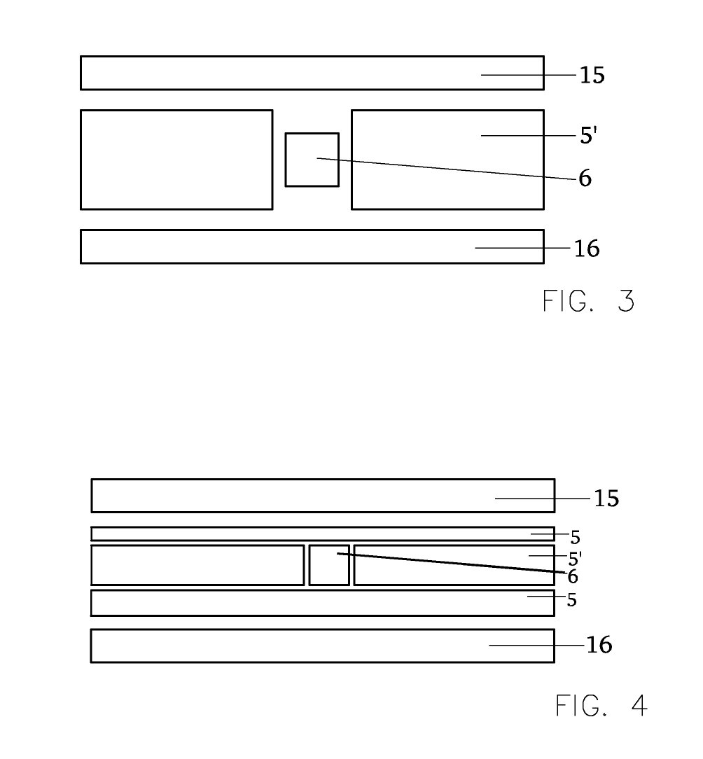

FIG. 3 shows schematically a first embodiment of the one step process, according to the present invention, in which prelaminate V [15]; a punched PETG film [5′] with a module [6] in the punched out part; and prelaminate VI [16] are directly laminated together in a laminator (see INVENTION EXAMPLES 1 to 17). The two sides of the security laminate resulting from the one step process shown in FIG. 3 can be further laminated with a protective laminate [13] e.g. a PET-C/PE laminate and a further protective laminate [13′] e.g. a PET-C/PE laminate respectively.(see FIG. 8)

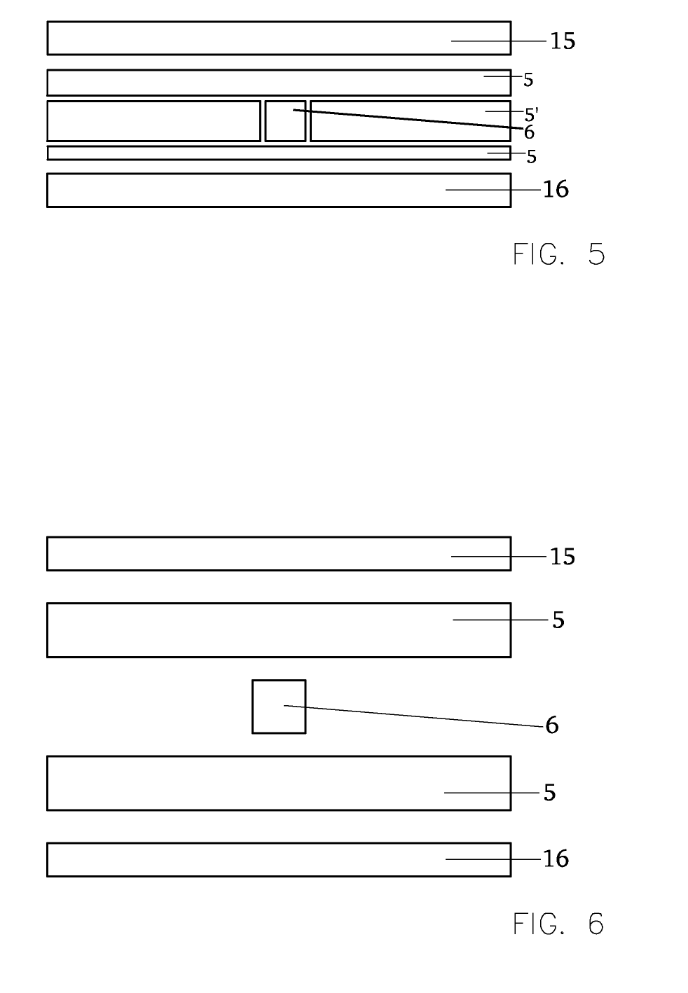

In the context of identity cards with an ID-1 format, as defined in ISO 7810, a 500 μm thick prepunched e.g. PETG core can be used, but as shown schematically in FIGS. 4 and 5 a thinner prepunched e.g. PETG core can be used (e.g. 300 μm thick) with non-punched films sandwiching it. Moreover, these sandwiching films need not have the same thickness. Furthermore, as shown in FIG. 6, the use of a prepunched core can be dispensed with altogether.

In a preferred embodiment of the process for producing a security laminate, according to the present invention, the contactless module is placed in a film with a hole therefor. It is preferred that the gap between the contactless module and the hole rim be no more than 0.1 mm to keep any air inclusion to a minimum, but larger gaps are also acceptable.

In a preferred embodiment of the process for producing a security laminate, according to the present invention, no film with a hole is provided for placing the contactless module therein.

FIG. 4 shows schematically a second embodiment of the one step process, according to the present invention, in which prelaminate V [15]; a PETG film [5]; a thinner punched PETG film [5′] with a module [6] in the punched out part; a thicker PETG film [5]; and prelaminate VI [16] are directly laminated together in a vacuum laminator (see EXAMPLES 22, 24 and 26). The two sides of the security laminate resulting from the one step process shown in FIG. 4 can be further laminated with a protective laminate [13] e.g. a PET-C/PE laminate and a further protective laminate [13′] e.g. a PET-C/PE laminate respectively.

FIG. 5 shows schematically a third embodiment of the one step process, according to the present invention, in which prelaminate V [15]; a PETG film [5]; a thinner punched PETG film [5′] with a module [6] in the punched out part; a thinner PETG film [5]; and prelaminate VI [16] are directly laminated together in a laminator. The two sides of the security laminate resulting from the one step process shown in FIG. 5 can be further laminated with a protective laminate [13] e.g. a PET-C/PE laminate and a further protective laminate [13′] e.g. a PET-C/PE laminate respectively.

FIG. 6 shows schematically a fourth embodiment of the one step process, according to the present invention, in which prelaminate V [15]; a PETG film [5]; a module [6]; a PETG film [5]; and prelaminate VI [16] are directly laminated together in a laminator (see EXAMPLES 18, 19, 20, 21 and 23). The two sides of the security laminate resulting from the one step process shown in FIG. 6 can be further laminated with a protective laminate [13] e.g. a PET-C/PE laminate and a further protective laminate [13′] e.g. a PET-C/PE laminate respectively.

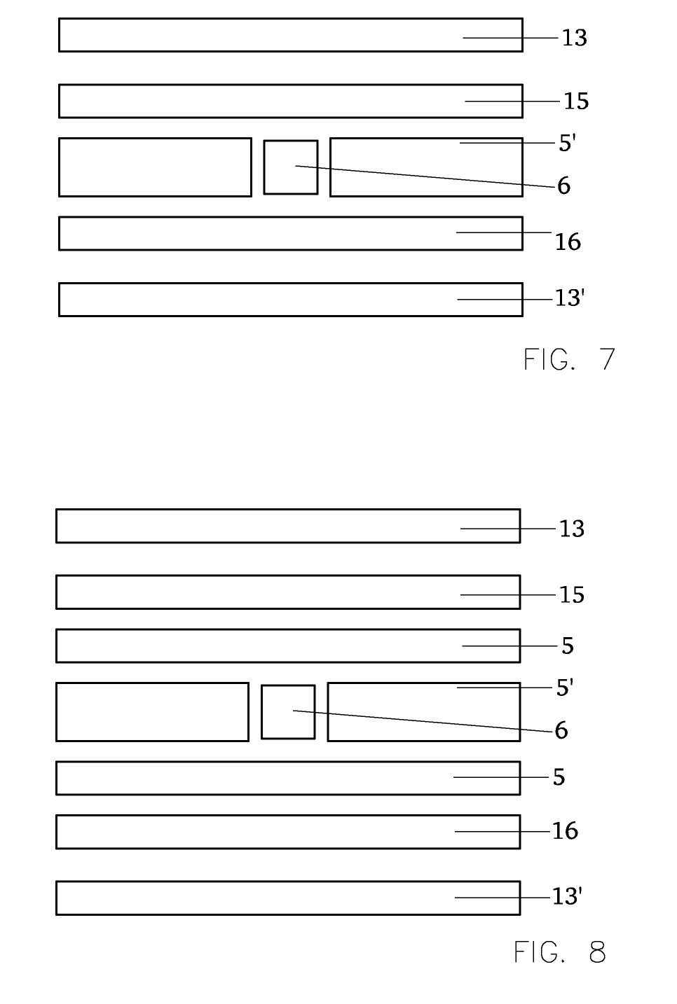

FIGS. 7 to 9 show identical processes to those shown in FIGS. 3 to 6 respectively except that lamination with a protective laminate on both sides is foreseen. Such lamination can indeed be performed in a separate step.

FIG. 7 shows schematically a fifth embodiment of the one step process, according to the present invention, in which a protective laminate [13] e.g. a PET-C/PE laminate; prelaminate V [15]; a punched PETG film [5′] with a module [6] in the punched out part; prelaminate VI [16]; and a further protective laminate [13′] are directly laminated together in a laminator.

FIG. 8 shows schematically a sixth embodiment of the one step process, according to the present invention, in which a protective laminate [13] e.g. a PET-C/PE laminate; prelaminate V [15]; a PETG film [5]; a thinner punched PETG film [5′] with a module [6] in the punched out part; a further PETG film [5]; prelaminate VI [16]; and a further protective laminate [13′] are directly laminated together in a laminator.

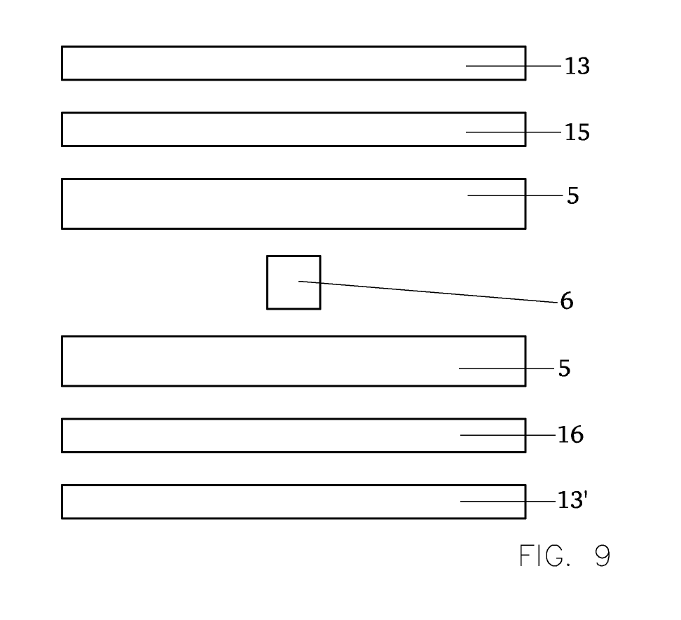

FIG. 9 shows schematically a seventh embodiment of the one step process, according to the present invention, in which a protective laminate [13] e.g. a PET-C/PE laminate; prelaminate V [15]; a PETG film [5]; a module [6]; a further PETG film [5]; prelaminate VI [16]; and a further protective laminate [13′] are directly laminated together in a laminator.

In a preferred embodiment of the process for producing a security laminate, according to the present invention, the major surfaces of the contactless module are prelaminated with a film, with prelamination with an opaque film being preferred.

In a preferred embodiment of the process of the process for is producing a security laminate, according to the present invention, the major surfaces of the contactless module are not prelaminated with a film.

### Biaxially Oriented Polyester Lamella

The thickness of the oriented polymeric lamella employed in the present invention can be between 6 μm and 250 μm. Any orientable polyester can be used in the security laminates, adhesion systems and processes, according to the present invention.

In a preferred embodiment of the invention, a linear polyester is employed. Such a material is well known to those skilled in the art and is obtained by condensing one or more dicarboxylic acids or their lower (up to 6 carbon atoms) diesters, e.g., terephthalic acid, isophthalic acid, phthalic acid, 2,5-, 2,6- or 2,7-naphthalenedicarboxylic acid, succinic acid, sebacic acid, adipic acid, azelaic acid, 4,4′-diphenyldicarboxylic acid, hexahydroterephthalic acid or 2-bis-p-carboxyphenoxyethane (optionally with a monocarboxylic acid, such as pivalic acid), the corresponding dicarboxylic acid dialkyl ester or lower alkyl ester with one or more glycols, e.g., ethylene glycol, 1,3-propanediol, 1,4-butanediol, neopentyl glycol and 1,4-cyclohexanedimethanol. In a preferred embodiment, the polyester polymer is obtained by condensing terephthalic acid or 2,6-naphthalenedicarboxylic acid or their dimethyl esters with ethylene glycol. In another preferred embodiment, the polymer is PET. The PET film prepared from the above-described composition must be oriented. In a preferred embodiment, the PET film is biaxially-oriented. Such a process is described in many patents, such as GB 838,708, the disclosure of which is hereby incorporated by reference. These techniques are well known to those skilled in the art.

According to a sixteenth embodiment of the process, according to the present invention, the security laminate comprises at least one axially stretched linear polyester film and the polyester is an orientable polyester with polyesters comprising monomer units selected from the group consisting of terephthalate units, isophthalate units, naphthalate units, ethylene units, neopentylene units, 1,4-cyclohexane dimethylene units and —CH₂CH₂OCH₂CH₂— units being preferred e.g. polyethylene terephthalate (PET), polyethylene naphthalate (PEN).

### INDUSTRIAL APPLICATION

The security laminates and adhesion systems, according to the present invention, can be used in identity documents such as driver's licenses, ID-cards and passports, and on other important documents such as certificates of title. Security laminates are also useful as tamper proof seals on medications, video cassettes, and compact discs.

The invention is illustrated hereinafter by way of COMPARATIVE EXAMPLES and INVENTION EXAMPLES. The percentages and ratios given in these examples are by weight unless otherwise indicated.

MEK=methyl ethyl ketone
KIESELSOL™ 100F=a 36% aqueous dispersion of colloidal silica from BAYER;
MERSOLAT™ H=an alkyl sulphonate surfactant from BAYER;
Arkopal™ N060=a nonyl-phenyl-oxy-polyethylene-glycol(EO 6) from Avecia
Arkopon™ T8015=a sodium salt of N-methyl-N-2-sulfoethyl-oleylamide from Avecia, supplied as a 40% concentrate

### ADHESION LAYERS:

Subbing layer 1:

| | |
|---|---|
| copolymer of vinylidene chloride, methyl acrylate and | 151 |
| itaconic acid 88:10:2 by weight [mg/m²]: | |
| colloidal silica (KIESELSOL ™ 100F) [mg/m²]: | 35 |
| Mersolat ™ H [mg/m²]: | 0.75 |
| Coating weight [mg/m²]: | 187 |
| Coating thickness [μm]: | ca. 0.19 |

subbing layer 2:

| | |
|---|---|
| copolymer of vinylidene chloride, methyl acrylate and | 147.3 |
| itaconic acid 88:10:2 by weight [mg/m²]: | |
| poly(3,4-ethylenedioxythiophene)/PSS [mg/m²]: | 2.58 |
| colloidal silica (KIESELSOL ™ 100F) [mg/m²]: | 16.4 |
| Mersolat ™ H [mg/m²]: | 0.74 |
| Coating weight [mg/m²]: | 167 |
| Coating thickness [μm]: | ca. 0.17 |

### Lamination of 35 μm PETG-film to 23 μm PET-C:

The PET-C film was provided on one side with subbing layer 1 and an adhesion layer with the following composition:

| | |
|---|---|
| Gelatin [mg/m²] | 380 |
| colloidal silica (KIESELSOL ™ 100F) [mg/m²]: | 340.7 |
| Arkopon ™ T8015 [mg/m²]: | 3.33 |
| Arkopal ™ N060 [mg/m²]: | 6.67 |
| 1 μm diameter polymethylmethacrylate particles [mg/m²]: | 0.04 |
| Coating weight [mg/m²]: | 730.7 |
| Coating thickness [μm]: | ca. 0.73 |

and on the other side with subbing layer 2 and an adhesion layer with the following composition:

| | |
|---|---|
| Gelatin [mg/m²] | 380 |
| colloidal silica (KIESELSOL ™ 100F) [mg/m²]: | 340.8 |
| Arkopon ™ T8015 [mg/m²]: | 3.3 |
| Arkopal ™ N060 [mg/m²]: | 6.7 |
| 3 μm diameter polymethylmethacrylate particles | 1.7 |
| Coating weight [mg/m²]: | 732.5 |
| Coating thickness [μm]: | ca. 0.73 |

and then a layer of Liofol™ UK 3640 with Liofol™ hardener 6800 both from Henkel was coated from a methylethylketone solution. The PETG-film or PE-film was then laminated thereon using a roll laminator at room temperature.

The 23 μm PET-C film was coated with Liofol UK 3640 with Liofol hardener 6800.

LAMINATE PRECURSORS (or prelaminates):
laminate precursor (prelam) I [8]:

A 63 μm PET-C film provided with subbing layer 1 on one side and subbing layer 2 (antistatic layer) on the other side was coated on one side with a sequence of layer consisting of a gelatinous layer, a gelatinous DTR-receiving layer and a protective layer. The protective layer was then laminated to a 30 μm PE/23 μm PET-C-laminate with the PET-C film outermost resulting in the following configuration:
23 μm PET-C/30 μm PE/protective layer/gelatinous DTR-receiving layer containing a DTR-image/gelatinous layer/63 μmPET-C/polyurethane-adhesive
   laminate precursor (prelam) II [10]:

A 63 μm PET-C film provided with subbing layer 1 on one side and subbing layer 2 (antistatic layer) on the other side was coated on one side with a sequence of layer consisting of a gelatinous layer and a protective layer. The protective layer was then laminated to a 30 μm PE/23 μm PET-C-laminate with the PET-C film outermost resulting in the following configuration:
polyurethane-adhesive/63 μm PET-C/gelatinous layer/protective layer/30 μm PE/23 μm PET-C
   laminate precursor (prelam) III [11]:

A 63 μm PET-C film provided with subbing layer 1 on one side and subbing layer 2 (antistatic layer) on the other side was coated on one side with a sequence of layer consisting of a gelatinous layer, a gelatinous DTR-receiving layer and a protective layer resulting in the following configuration:
protective layer/gelatinous DTR-receiving layer containing a DTR-image/gelatinous layer/63 μmPET-C/polyurethane-adhesive
   laminate precursor (prelam) IV [12]:

A 63 μm PET-C film provided with subbing layer 1 on one side and subbing layer 2 (antistatic layer) on the other side was coated on one side with a sequence of layer consisting of a gelatinous layer and a protective layer resulting in the following configuration:
polyurethane-adhesive/63 μm PET-C/gelatinous layer/protective layer
   security laminate [14]:

A laminate of laminate precursor III, laminate precursor VII and laminate precursor IV.

laminate precursor (prelam) V [15]:

A 63 μm PET-C film provided with subbing layer 1 on one side and is subbing layer 2 (antistatic layer) on the other side was laminated on one side with a 35 μm PETG film and coated on the other side with a sequence of layer consisting of a gelatinous layer, a gelatinous DTR-receiving layer and a protective layer resulting in the following configuration:
protective layer/gelatinous DTR-receiving layer containing a DTR-image/gelatinous layer/63 μm PET-C/polyurethane-adhesive/35 μm PETG
   laminate precursor (prelam) VI [16]:

A 63 μm PET-C film provided with subbing layer 1 on one side and subbing layer 2 (antistatic layer) on the other side was laminated on one side with a 35 μm PETG film and coated on the other side with a sequence of layer consisting of a gelatinous layer and a protective layer resulting in the following configuration:
35 μm PETG/polyurethane-adhesive/63 μm PET-C/gelatinous layer/protective layer

### CONTACTLESS MODULE:

The contactless module used was supplied by SPS with a chip and an antenna to which the chip was connected mounted on a single support.

### COMPARATIVE EXAMPLE 1

### Two Step Process

The security laminate COMPARATIVE EXAMPLE 1 was produced in a two step process. In the first step prelaminate VII [9] was produced by laminating for 10 minutes at a pressure of 8.5 bar at a temperature of 130° C. a sandwich of two 35 μm PETG films either side of a punched 500 μm PETG film with a contactless module in the punched out hole.

In the second step the configuration prelaminate I/prelaminate VII/prelaminate II was laminated for 17.5 minutes at a temperature of 140° C. and pressure of 60 bar with a pressure of 5 bar being applied for 5 minutes, then a pressure of 120 bar for 4 minutes and finally 200 bar for 5 minutes during the cooling process.

The final thickness of the security laminate of COMPARATIVE EXAMPLE 1 was 981 μm compared with a combined thickness of the lamellae and layer of ca. 820 μm indicating very considerable is topographical increase due to buckling of the support of the contactless module.

### INVENTION EXAMPLES 1 to 26

### One Step Process Without Vacuum

The security laminates of INVENTION EXAMPLES 1 to 26 were produced in a one step process by laminating together different precursor security laminates and lamellae in the configurations given in Table 1 below using an OASYS™ OLA6/7 laminator from OASYS Technologies Ltd with the different configurations being placed between two stainless 25 steel plates with silicone paper in between to prevent sticking under the conditions given for the appropriate lamination experiment in Table 1 with: LT being the lamination temperature, LP being the lamination pressure in nominal units, HT being the time in s at which the configuration is held at the lamination temperature, HPT 30 being the temperature at which the pressure is changed, ect being the temperature in ° C. at which the resulting security laminate can be removed from the laminator Top [=topography] being the final thickness in μm of the security laminate in the format of an identity card with an ID-1 format as defined in ISO 7810.

TABLE 1

| Invention | | | | | | | | |
|---|---|---|---|---|---|---|---|---|
| example | | | | | | | | |
| nr | Configuration | LT | LP | HT | HPT | HP | ect | Top |
| 1 | prelamV/500 μmPETG-□/module*/prelamVI | 150 | 33 | 150 | 130 | 30 | 50 | 917 |
| 2 | prelamV/500 μmPETG-□/module*/prelamVI | 150 | 20 | 150 | 130 | 30 | 50 | 935 |
| 3 | prelamV/500 μmPETG-□/module*/prelamVI | 150 | 21 | 150 | 130 | 30 | 50 | 939 |
| 4 | prelamV/500 μmPETG-□/module*/prelamVI | 150 | 22 | 150 | 130 | 30 | 50 | 883 |
| 5 | prelamV/500 μmPETG-□/module*/prelamVI | 150 | 23 | 150 | 130 | 30 | 50 | 913 |
| 6 | prelamV/500 μmPETG-□/module*/prelamVI | 150 | 25 | 150 | 130 | 30 | 50 | 934 |
| 7 | prelamV/500 μmPETG-□/module*/prelamVI | 150 | 27 | 150 | 130 | 30 | 50 | 924 |
| 8 | prelamV/500 μmPETG-□/module*/prelamVI | 150 | 29 | 150 | 130 | 30 | 50 | 919 |
| 9 | prelamV/500 μmPETG-□/module*/prelamVI | 150 | 31 | 150 | 130 | 30 | 50 | 886 |
| 10 | prelamV/500 μmPETG-□/module*/prelamVI | 140 | 30 | 150 | 130 | 30 | 50 | 906 |
| 11 | prelamV/500 μmPETG-□/module*/prelamVI | 144 | 30 | 150 | 130 | 30 | 50 | 872 |
| 12 | prelamV/500 μmPETG-□/module*/prelamVI | 146 | 30 | 150 | 130 | 30 | 50 | 900 |
| 13 | prelamV/500 μmPETG-□/module*/prelamVI | 150 | 30 | 150 | 130 | 30 | 50 | 927 |
| 14 | prelamV/500 μmPETG-□/module*/prelamVI | 152 | 30 | 150 | 130 | 30 | 50 | 879 |
| 15 | prelamV/500 μmPETG-□/module*/prelamVI | 154 | 30 | 150 | 130 | 30 | 50 | 856 |
| 16 | prelamV/500 μmPETG-□/module*/prelamVI | 156 | 30 | 150 | 130 | 30 | 50 | 880 |
| 17 | prelamV/500 μmPETG-□/module*/prelamVI | 158 | 30 | 150 | 130 | 30 | 50 | 708 |
| 18 | prelamV/100 μmPETG/100 μmPETG/module/ | 150 | 30 | 150 | 130 | 30 | 50 | 896 |
| | 100 μmPETG/100 μmPETG/100 μmPETG/prelamVI | | | | | | | |
| 19 | prelamV/100 μmPETG/100 μmPETG/100 μmPETG/ | 150 | 30 | 150 | 130 | 30 | 50 | 832 |
| | 100 μmPETG/module/100 μmPETG/prelamVI | | | | | | | |
| 20 | prelamV/100 μmPETG/150 μmPETG/module/ | 150 | 30 | 150 | 130 | 30 | 50 | 827 |
| | 100 μmPETG/100 μmPETG/prelamVI | | | | | | | |
| 21 | prelamV/150 μmPETG/100 μmPETG/module/ | 155 | 30 | 150 | 130 | 30 | 50 | 847 |
| | 100 μmPETG/100 μmPETG/prelamVI | | | | | | | |
| 22 | prelamV/100 μmPETG/100 μmPETG-□/ | 150 | 30 | 150 | 130 | 30 | 50 | 815 |
| | 100 μmPETG-□/module/100 μmPETG/ | | | | | | | |
| | 100 μmPETG/prelamVI | | | | | | | |
| 23 | prelamV/100 μmPETG/100 μmPETG/module/ | 150 | 30 | 150 | 130 | 30 | 50 | 807 |
| | 100 μmPETG/100 μmPETG/100 μmPETG/prelamIV | | | | | | | |
| 24 | prelamV/100 μmPETG/100 μmPETG-□/module/ | 150 | 30 | 150 | 130 | 30 | 50 | 786 |
| | 100 μmPETG/100 μmPETG/100 μmPETG/prelamVI | | | | | | | |
| 25 | prelamV/100 μmPETG/100 μmPETG/module/ | 150 | 30 | 150 | 130 | 30 | 50 | 835 |
| | 100 μmPETG-□/100 μmPETG/100 μmPETG/ | | | | | | | |
| | prelamVI | | | | | | | |
| 26 | prelamV/100 μmPETG/100 μmPETG-□/ | 150 | 30 | 150 | 130 | 30 | 50 | 874 |
| | module/100 μmPETG-□/100 μmPETG/ | | | | | | | |
| | 100 μmPETG/prelamVI | | | | | | | |

*module prelaminated with PETG/PU-adhesive layer on both sides
□ = prepunched

From the results in Table 1 it is clear that the security laminates of INVENTION EXAMPLES 1 to 26 produced by the one step process in the OASYS OLA6/7 laminator surprisingly resulted in security laminate thicknesses considerably lower than the 981 μm for the security laminate of COMPARATIVE EXAMPLE 1 using a two step process. This indicates that the buckling of the contactless module was considerably reduced by using the one step process for a wide variety of lamination configurations over the situation using a two step process. Furthermore, no black rim was observed indicating that there were no problems due to thinning of the masking opaque film.

Moreover, as can be seen with the security laminates of INVENTION EXAMPLES 1 to 17 in which the same configuration was laminated under different lamination conditions with a contactless module prelaminated with PETG/PU-adhesive layer on both sides, the degree of buckling could be minimized by varying the lamination conditions. For example at a lamination temperature of 150° C. thicknesses, allowing for statistical variation, the security laminate thickness decreased upon increasing the pressure from 20 to 31 units from 939 μm to 886 μm; and at a pressure of 30 units the security laminate thickness decreased upon increasing the temperature from 140 to 154° C. from 906 to 856 μm.

Furthermore, the security laminates of INVENTION EXAMPLES 18 to 20 and 22 to 26 using identical lamination conditions showed with the same contactless module but without prelamination with PETG/PU-adhesive layer on both sides could also be used in the one step process with in general still lower thicknesses being observed.

Additional benefits of the one step process are an increased productivity both through the simplified lamination processes and due to an elimination of rejected prelamVII units due to poor/incomplete embedding of the module.

Small air bubbles were present in all the security laminates of INVENTION EXAMPLES 1 to 26, but these are not functionally disadvantageous.

### INVENTION EXAMPLES 27 and 28

### One Step Process with Vacuum

The security laminates of INVENTION EXAMPLES 27 and 28 were produced in a one step process by placing prelaminate V/a prepunched 500 μmPETG with a contactless module prelaminated with PETG/PU-adhesive layer on both sides in the punched hole/prelaminate VI between two 1 mm thick steel plates with silicone paper between the outermost precursor and the plate in a Lauffer Lamination system Type LC 70 vacuum laminator and laminating for 10 minutes at a temperature of 145° C., a pressure of 40 N/cm² and a vacuum of 20 mbar. Heating was performed with preheated oil and cooling is performed with tap-water. Heating was started upon closure of the laminator, but pressure was only applied once the required vacuum had been realized, i.e. after ca. 3 minutes, and was maintained though the 10 minute lamination process and the subsequent cooling.

A security laminate thickness of 712 μm was obtained which was consistent with or better than the results obtained with the security laminates of INVENTION EXAMPLES 1 to 17 indicating minimal buckling of the contactless module. Moreover, air bubbles due to air entrapment were minimal.

The present invention may include any feature or combination of features disclosed herein either implicitly or explicitly or any generalisation thereof. In view of the foregoing description it will be evident to a person skilled in the art that various modifications may be made within the scope of the invention.

1-12. (canceled)

13. A process for producing a security laminate comprising a plurality of lamellae and layers comprising the steps of:
(a) providing at least one film, at least a first and a second prelaminate and a contactless module, wherein the contactless module is not incorporated in the prelaminate or the film; and
(b) laminating in one step together the at least first prelaminate, the at least one film, the contactless module and the at least second prelaminate to provide the security laminate.

14. The process according to claim 13, wherein the at least one film contains a punched out part wherein the contactless module can be placed.

15. The process according to claim 13, wherein the at least one film is a PETG film.

16. The process according to claim 14, wherein the at least one film is a PETG film.

17. The process according to claim 13, wherein the lamination is performed in a vacuum laminator.

18. The process according to claim 13, wherein the security laminate comprises at least one axially stretched linear polyester film.

19. The process according to claim 17, wherein at least one of the outermost lamellae of the security laminate is an axially stretched linear polyester film.

20. The process according to claim 17, wherein at least one of the outermost lamellae of the security laminate is a biaxially stretched linear polyester film.

21. The process according to claim 13, wherein the security laminate comprises at least one lamella selected from the group consisting of crystalline polyester lamellae, amorphous polyester lamellae, polycarbonate lamellae, polyolefin lamellae and polyvinyl chloride lamellae.

22. The process according to claim 13, wherein at least one prelaminate comprises a gelatinous DTR-receiving layer.

23. The process according to claim 13, wherein the security laminate is an identity document.

24. The process according to claim 13, wherein the security laminate is an identification card.

25. A security laminate obtainable by the process according to claim 13.

26. A security laminate obtainable by the process according to claim 14.

27. A security laminate obtainable by the process according to claim 15.

28. A security laminate obtainable by the process according to claim 16.

29. A security laminate obtainable by the process according to claim 17.

30. A security laminate obtainable by the process according to claim 18.

31. A security laminate obtainable by the process according to claim 19.

32. A security laminate obtainable by the process according to claim 20.

33. A security laminate obtainable by the process according to claim 21.

34. A security laminate obtainable by the process according to claim 22.

35. A security laminate obtainable by the process according to claim 23.

36. A security laminate obtainable by the process according to claim 24.
